(19) United States
(12) Patent Application Publication
(10) Pub. No.: US 2015/0070141 A1
(43) Pub. Date: Mar. 12, 2015

(54) WIRELESS CONTROL SYSTEM AND METHOD OF SETTING THE CONTROL SYSTEM

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); YEN-JEN YEH, Yunlin (TW); YU-CHIN TSAI, Kaohsiung (TW)

(73) Assignee: GRAND MATE CO., LTD., Taichung (TW)

(21) Appl. No.: 14/260,469

(22) Filed: Apr. 24, 2014

(30) Foreign Application Priority Data
Sep. 11, 2013 (TW) 102132817

(51) Int. Cl. G08C 17/02

(52) U.S. Cl. CPC G08C 17/02
USPC 340/12.5

(57) ABSTRACT

A wireless control system for controlling a plurality of electric elements, includes a control signal generator, at least a converting device, and a plurality of controlling devices. The control signal generator generates a Wi-Fi control signal and sends it to the converting device. The converting device converts the Wi-Fi control signal into a radio frequency control signal, and sends the radio frequency control signal to the controlling devices. The controlling devices are connected to the electric elements respectively to receive the radio frequency control signal from the converting device and control the electric elements accordingly.

The current application claims a foreign priority to the patent application of Taiwan No. 102132817 filed on Sep. 11, 2013.

### BACKGROUND OF THE INVENTION

1. Technical Field

The present invention relates generally to a control system, and more particular to a wireless control system, and a method of setting the control system.

2. Description of Related Art

As the development of technology, there are various electric appliances in ordinary homes, such as gas stove, electrical water heater, fan, and so on. There usually is a control device on an electric appliance for manual control of the electric appliance. However, people have to approach the electric appliance to operate the control device. it is very inconvenient for a person who wants to control an electric appliance which is far away, such as an outdoor water heater.

To improve above drawback, a remote control, which is equipped with radio frequency (RF) module to generate RF signals, is provided for control of a specific electric appliance, so that people may control the electric appliances with the specified remote controls.

The remote control provides an easy way of controlling the electric appliance, however, we have more and more remote controls at home as we get more electric appliances. So, we spend longer time in finding the remote control than the time we walk to the electric appliance and operate the control device on it. Besides, as the development of wireless network, most of ordinary homes have Wi-Fi networks. It will be very convenient if the electric appliances at home could be controlled through the Wi-Fi network.

### BRIEF SUMMARY OF THE INVENTION

In view of the above, the primary objective of the present invention is to provide a wireless control system and a method of setting the control system, which converts Wi-Fi signals into RF signals to control a plurality of electric elements of an electric appliance at the same time.

The present invention provides a wireless control system for controlling a plurality of electric elements, including a control signal generator for transmitting a Wi-Fi control signal; at least a converting device receiving the Wi-Fi control signal from the control signal generator, and converting the Wi-Fi control signal into a radio frequency control signal; and a plurality of controlling devices, which are connected to the electric elements respectively, each having a radio frequency transceiver and a controller, wherein the radio frequency transceivers receive the radio frequency control signal from the converting device and send the radio frequency control signal to the controllers, and then the controllers respectively control the electric elements according to the radio frequency control signal.

In an embodiment, the control signal generator includes an electronic device and a wireless access point, both of which are connected to a network; the electronic device generates a control signal and transmits the control signal to the wireless access point through the network; the wireless access point converts the control signal into the Wi-Fi control signal, and then transmits the Wi-Fi control signal to the converting device.

In an embodiment, the converting device includes a Wi-Fi module, a multiplexing module, and a radio frequency module; the Wi-Fi module receives the Wi-Fi control signal from the control signal generator and sends the Wi-Fi control signal to the multiplexing module; the multiplexing module converts the Wi-Fi control signal into the radio frequency control signal; and the radio frequency module transmits the radio frequency control signal to the radio frequency transceivers of the controlling devices.

The present invention further provides a method of setting a wireless control system, which includes the following steps:

A. Connect the electronic device to the converting device;

B. Transmit a connection data from the electronic device to the converting device, and save the connection data in the converting device;

C. Connect the converting device to the wireless access point through Wi-Fi according to the connection data; and

D. Disconnect the electronic device to the converting device, and keep a connection between the converting device and the wireless access point.

In an embodiment, the method further includes the step of connecting the electronic device to the wireless access point after the step D.

With such design, it may convert the Wi-Fi signals into the RF signals to control a plurality of the electric elements at the same time.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of the wireless control system of a preferred embodiment of the present invention;

FIG. 2 is block diagram of the controlling device of the preferred embodiment of the present invention; and

FIG. 3 is a block diagram of the converting device of the preferred embodiment of the present invention.

### DETAILED DESCRIPTION OF THE INVENTION

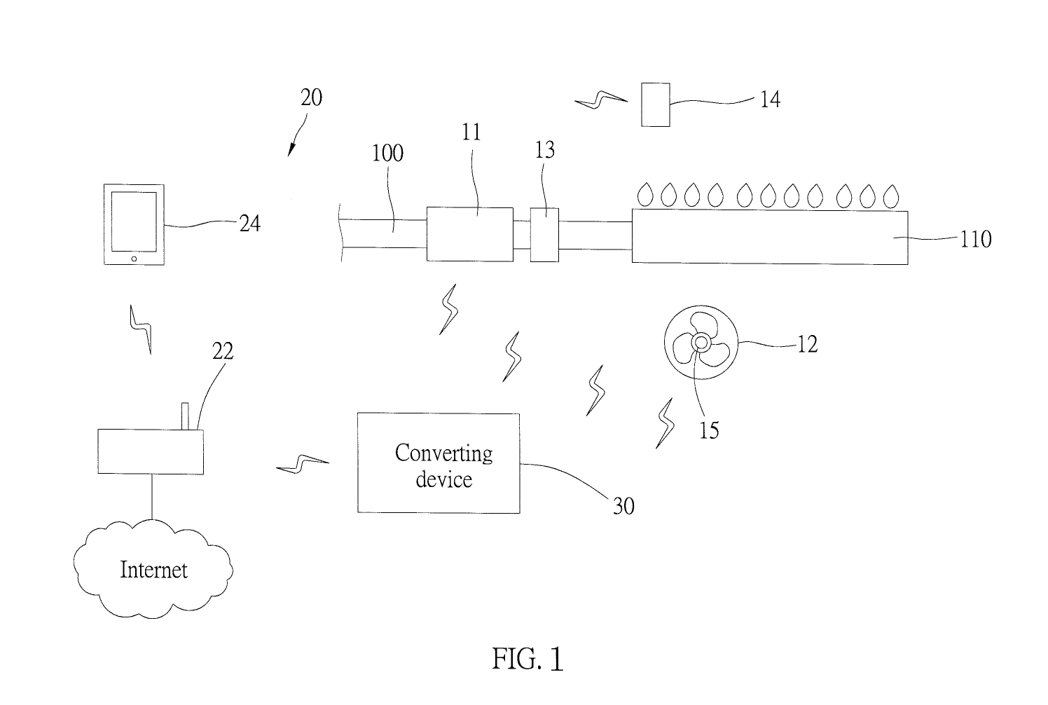

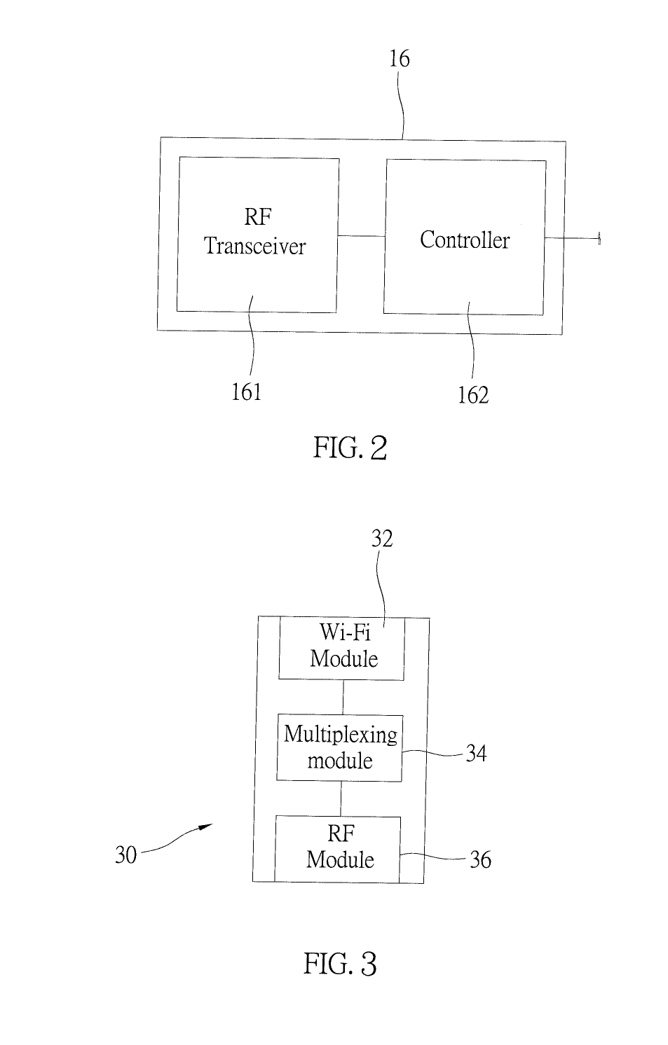

As shown in FIG. 1 and FIG. 2, a wireless control system of the preferred embodiment of the present invention is adapted to monitor and control a plurality of electric elements 11-15 of an electric appliance, including a plurality of controlling devices 16, a control signal generator 20, and a converting device 30.

In an embodiment of the present invention, the electric appliance is a fireplace, and the electric elements of the electric appliance include a solenoid valve 11, a blower 12, and three sensors 13-15. The solenoid valve 11 is mounted in a gas pipe 100, which supplies gas with burners 110 of the fireplace. The solenoid valve 11 works according to an electric signal to turn the solenoid valve 11 on/off, or to adjust a gas flow through the solenoid valve 11. In an embodiment, the solenoid valve 11 uses the solenoid valve taught in U.S. patent 2009/0206291A1, which is a ratio solenoid valve to be controlled by a voltage of the electric signal. In practice, any solenoid valve which is controlled by electric signals should be applied in the present invention. The blower 12 supplies air flow to the burners 110. The sensor 13 is provided on the gas pipe 100 between the burners 110 and the solenoid valve 11, the sensor 14 is beside the burners 110, and the sensor 15 is on the blower 12. The sensors 13-15 respectively sense a gas flow in the gas pipe 100, a temperature of the burners 110, and a speed of a motor of the blower 12.

The controlling devices 16 are connected to the electric elements 11-15 respectively, each of which has a radio frequency (RF) transceiver 161 and a controller 162. The RF transceiver 161 transmits and receives RF signals, and the controller 162 controls the corresponding electric element according to the RF signals received by the RF transceiver 161.

The control signal generator 20 includes a wireless access point (wireless AP) 22 and a smart phone 24. The wireless AP 22 connects to a network, such as Internet, and the smart phone 24 connects to the wireless AP 22 through Wi-Fi. A specific application is installed in the smart phone 24 for user to input commands, which control the electric elements 11-15 for specific actions, such as turn on/off or adjust the electric elements 11-15. The smart phone 24 may be replaced by any electronic device, such as desktop, laptop, tablet, or PDA, which may code and package the commands into control signals, and the control signals will be sent to the electric appliance eventually by wireless transmission.

As shown in FIG. 3, the converting device 30 includes a Wi-Fi module 32, a multiplexing module 34, and a radio frequency (RF) module 36 in serial connection. The Wi-Fi module 32 transmits and receives Wi-Fi signals, the multiplexing module 34 converts the Wi-Fi signals from the Wi-Fi module 32 into RF signals, and RF module 36 transmits the RF signals out.

A user has to set the wireless control system before use the smart phone 24 to control the electrical devices 11-15. First, the user has to operate the smart phone 24 to connect the smart phone 24 to the Wi-Fi module 32 of the converting device 30 through Wi-Fi Direct, and then send a connection data, such as Service Set Identifier (SSID) and key, to the Wi-Fi module 32 of the converting device 30, and save the connection data in the Wi-Fi module 32. The connection data is pre-stored in the application installed in the smart phone 24, or it may be inputted by the user. Next, the Wi-Fi module 32 of the converting device 30 will connect to the specified wireless AP 22 through Wi-Fi according to the connection data, and then disconnect to the smart phone 24. Now, a connection is kept between the converting device 30 and the wireless AP 22 only. Next, the user operates the smart phone 24 again to connect the smart phone 24 to the wireless AP 22 through Wi-Fi, and the setting process is completed. It is noted that the smart phone 24 may connect to the wireless AP 22 through a wire.

After that, the user may inputs a command through the smart phone 24, and then the smart phone 24 converts it into a Wi-Fi control signal and sends the Wi-Fi control signal to the wireless AP 22 through Wi-Fi. Next, the wireless AP 22 transfers the Wi-Fi control signal to the Wi-Fi module 32 of the converting device 30. The multiplexing module 34 receives the Wi-Fi control signal from the Wi-Fi module 32, and converts it into a RF control signal. Next, the RF control signal is sent to the RF transceivers 161 of the electric elements 11-15 through the RF module 36, and then the controllers 162 will control the electric elements 11-15 according to the RF control signal. When the smart phone 24 is used to control the electric elements 11-15, it may connect to Internet at the same time.

With the wireless control system of the present invention, the user may control the electric elements 11-15 anywhere as long as the smart phone 24 can connect to Internet. The smart phone 24 transmits the wireless AP 22 the control signal through Internet, and then the wireless AP 22 converts the control signal into a Wi-Fi control signal and sends the Wi-Fi control signal to the converting device 30 to control the electric elements 11-15.

User may monitor the electric elements 11-15 through the wireless control system of the present invention as well. For example, the sensing results of the sensors 13-15 are sent to the RF module 36 of the converting device 30, by the control of the controllers 162, through the RF transceivers 161 respectively, and then are converted into Wi-Fi data signals by the multiplexing module 34. Next, the Wi-Fi data signals are sent to the wireless AP 22 through the Wi-Fi module 32, and then the wireless AP 22 sends the Wi-Fi data signals to the smart phone 24 through Internet. As a result, the smart phone may show the data of the electric elements 11-15 to get the information of the electric appliance.

Except for the smart phone 24, any electronic device which may connect to the wireless AP 22 or the converting device 30 through Wi-Fi may be applied in the present invention. For example, a desktop (not shown) may connect to the wireless AP 22 or the converting device 30 through an RJ-45 interface.

It may provide a plurality of the converting devices 30 in the system. Each converting device 30 is in connection with some of the electric elements respectively that may reduce the delay in signal transmission when there are too many electric elements in control.

It must be pointed out that the embodiments described above are only some preferred embodiments of the present invention. All equivalent structures which employ the concepts disclosed in this specification and the appended claims should fall within the scope of the present invention.

What is claimed is:

1. A wireless control system for controlling a plurality of electric elements, comprising:
a control signal generator for transmitting a Wi-Fi control signal;
at least a converting device receiving the Wi-Fi control signal from the control signal generator, and converting the Wi-Fi control signal into a radio frequency control signal; and
a plurality of controlling devices, which are connected to the electric elements respectively, each having a radio frequency transceiver and a controller, wherein the radio frequency transceivers receive the radio frequency control signal from the converting device and send the radio frequency control signal to the controllers, and then the controllers respectively control the electric elements according to the radio frequency control signal.

2. The wireless control system of claim 1, wherein the control signal generator includes an electronic device and a wireless access point, both of which are connected to a network; the electronic device generates a control signal and transmits the control signal to the wireless access point through the network; the wireless access point converts the control signal into the Wi-Fi control signal, and then transmits the Wi-Fi control signal to the converting device.

3. The wireless control system of claim 1, wherein the control signal generator includes an electronic device and a wireless access point connected to the electronic device; the electronic device generates a control signal and transmits the control signal to the wireless access point; the wireless access point converts the control signal into the Wi-Fi control signal, and then transmits the Wi-Fi control signal to the converting device.

4. The wireless control system of claim 1, wherein the control signal generator is connected to the converting device through Wi-Fi Direct.

5. The wireless control system of claim 1, wherein the converting device includes a Wi-Fi module, a multiplexing module, and a radio frequency module; the Wi-Fi module receives the Wi-Fi control signal from the control signal generator and sends the Wi-Fi control signal to the multiplexing module; the multiplexing module converts the Wi-Fi control signal into the radio frequency control signal; and the radio frequency module transmits the radio frequency control signal to the radio frequency transceivers of the controlling devices.

6. The wireless control system of claim 1, wherein each of the controllers generates a radio frequency data signal, which comes from the electric elements, and transmits the radio frequency data signal to the converting device through the radio frequency transceiver; and then the converting device converts the radio frequency data signal into a Wi-Fi data signal and sends the Wi-Fi data signal to the control signal generator.

7. The wireless control system of claim 1, wherein there are a plurality of the converting devices, each of which transmit the radio frequency control signal to some of the controlling devices.

8. A method of setting a wireless control system, which includes an electronic device, a wireless access point, and a converting device, wherein the converting device receives a Wi-Fi control signal and converts the Wi-Fi control signal into a radio frequency control signal; the method comprising the steps of:
A. connecting the electronic device to the converting device;
B. transmitting a connection data from the electronic device to the converting device, and saving the connection data in the converting device;
C. connecting the converting device to the wireless access point through Wi-Fi according to the connection data; and
D. disconnecting the electronic device to the converting device, and keeping a connection between the converting device and the wireless access point.

9. The method of claim 8, further comprising the step of connecting the electronic device to the wireless access point after the step D.

10. The method of claim 9, wherein both the electronic device and the wireless access point are connected to a network, and the electronic device is connected to the wireless access point through the network.

11. The method of claim 9, wherein the electronic device is connected to the wireless access point through Wi-Fi Direct.

12. The method of claim 8, wherein the connection data is stored in the electronic device prior to the step A.

13. The method of claim 10, wherein the connection data is inputted into the electronic device prior to the step B.

14. The method of claim 10, wherein the electronic device is connected to the converting device through a wire.

15. The method of claim 10, wherein the electronic device is connected to the converting device through Wi-Fi.
